(19) United States
(12) Patent Application Publication
(10) Pub. No.: US 2014/0337242 A1
(43) Pub. Date: Nov. 13, 2014

(54) SYSTEM AND METHOD FOR CANDIDATE MATCHING

(71) Applicants: Mark Henry Harris Bailey, Thornhill (CA); Adrian Andrei, Brampton (CA)

(72) Inventors: Mark Henry Harris Bailey, Thornhill (CA); Adrian Andrei, Brampton (CA)

(21) Appl. No.: 13/890,689

(22) Filed: May 9, 2013

(51) Int. Cl. G06Q 10/10

(52) U.S. Cl. CPC G06Q 10/1053
USPC 705/321

(57) ABSTRACT

A system and method for candidate matching using a recruiter applicant tracking system and by providing a top candidate for employment to a recruiter based on a job request of a hiring employer. A structured candidate experience is created based on free form information associated with a candidate. The candidate experience is also associated with a recruiter of a plurality of recruiters, and a plurality of structured candidate experiences are stored. A structured job description is created based on a free form job description associated with a hiring employer and with a recruiter of the plurality of recruiters. A score is determined between each structured candidate experience and structured job description associated with a recruiter. A match list is generated from the scores associated with the recruiter. The match list is displayed on a recruiter device.

### TECHNICAL FIELD

The present invention relates to a system and method for candidate matching. In particular, the invention facilitates recruiter tracking of multiple candidates and multiple employment positions.

### BACKGROUND

Recruitment can generally be described as the process of attracting, screening, and selecting qualified candidates for employment by a hiring company. Recruitment also includes developing and leveraging a broad network of associations between hiring employers and employment candidates. Recruitment can be conducted by a variety of entities including professional employment agencies, recruitment firms, in-house human resource departments, and individual recruiters.

Recruitment conducted by individual recruiters or at recruitment firms can be a time sensitive undertaking as often the first candidate submitted by one of a number of competing recruiters is accepted by a hiring employer. There is information disparity in the recruiting process as the relevant details required for candidate matching tend to be distributed amongst different parties. For example, a hiring employer may have specific requirements relevant to a job description, an employment candidate may have the best knowledge of his or her own experience, and a recruiter may have associations with a large number of candidates and employers.

A recruiter utilizing a conventional recruitment system must make a significant an effort to identify a candidate within a potential pool of thousands of candidates. This time consuming process can cause a recruiter to lose the opportunity to place a candidate to a faster-acting competing recruiter.

Existing applicant tracking systems are generally not recruiter specific. These systems may employ natural language processing to process candidate resumes and job descriptions by comparing elements extracted from such documents. However, they generally fail to capture and manipulate all of the distributed knowledge required for efficient candidate matching.

Existing recruitment systems bring the distributed knowledge of recruiters, hiring employers, and candidates together within an online open market. An example of such a system is disclosed in U.S. Patent Application Publication No. US 2012/0239585 A1 in the name of Mark Henry Harris Bailey, the contents of which are hereby incorporated by reference. However, this approach still may require a recruiter to compile large amounts of candidate related or job description related information.

Therefore, a need exists for a recruiter oriented matching system that provides automated matching between a are pool of candidates and a job description of a hiring employer, without the need for a recruiter to enter large amounts of information associated with candidates or employers.

### SUMMARY

The embodiments described herein provide in one aspect, a method for facilitating recruitment using an applicant tracking system to provide a top candidate for employment to a recruiter based on a job description of a hiring employer, the method comprising:

creating and storing at least one structured candidate experience based on free form information associated with a candidate, the candidate experience associated with a recruiter of a plurality of recruiters;

creating and storing a structured job description based on a free form job description associated with the hiring employer and with the recruiter;

determining a score between each structured candidate experience and the structured job description associated with the recruiter;

generating a match list from the scores associated with the recruiter; and

displaying the match list on a recruiter device.

The embodiments described herein provide, in yet another aspect, a non-transitory computer readable medium for:

creating and storing at least one structured candidate experience based on free form information associated with a candidate, the candidate experience associated with a recruiter of a plurality of recruiters;

creating arid storing a structured job description based on a free form job description associated with the hiring employer and with the recruiter;

determining a score between each structured candidate experience and the structured job description associated with the recruiter;

generating a match list from the scores associated with the recruiter; and

displaying the match list on a recruiter device.

The embodiments described herein provide in another aspect, an applicant tracking system for facilitating recruitment by providing a top candidate for employment to a recruiter based on a job request of a hiring employer, the system comprising:

a knowledge database;

a recruitment database;

a recruiter device; and

a search processor coupled to the knowledge database and recruitment database and operable to:

receive free form information associated with a candidate;

create at least one structured candidate experience based on the free form information associated with the candidate, the candidate associated with a recruiter of a plurality of recruiters;

store a plurality of structured candidate experiences in the recruitment database;

receive a free form job description associated with a hiring employer and with the recruiter;

create a structured job description based on the free form job description;

determine a score between each structured candidate experience and the structured job description associated with the recruiter;

generate a match list from the scores associated with the recruiter; and

display the match list on a recruiter device.

In an aspect of these embodiments, creating the structured candidate experience comprises assigning hierarchical dimensions to the free form information associated with the employment candidate; creating the structured job description comprises assigning hierarchical dimensions to the free form job description; and the hierarchical dimensions are defined in a knowledge database.

In another aspect of these embodiments, assigning the hierarchical dimensions comprises using rule based matching to determine a number of keyword matches between the hierarchical dimensions of the knowledge database and the free form information associated with the employment candidate or the free form job description.

In another aspect of these embodiments, determining the score for each structured candidate experience comprises calculating a distance between the hierarchical dimensions of the structured candidate experience and the hierarchical dimensions of the structured job description.

In another aspect of these embodiments creating structured ranking information is based on at least one of: default rank criteria, free form ranking information associated with a hiring employer, and the structured job description. In this aspect, the structured ranking information comprising hierarchical dimensions defined in the knowledge database and the score for each structured candidate experience is further based on the structured ranking information.

In another aspect of these embodiments, the generated match list comprises a subset of the plurality of structured candidate experiences. In this aspect, the subset comprises the structured candidate experiences with scores having a minimum calculated distance between the hierarchical dimensions of the structured candidate experience and the hierarchical dimensions of the structured job description.

Another aspect of these embodiments comprises receiving a recruiter submission at a hiring employer device. In this embodiment, the recruiter submission comprises a match list.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a recruiter applicant tracking system and related entities in accordance with at least one embodiment;

FIG. 2A is a block diagram of the recruitment applicant tracking system of FIG. 1 in accordance with at least one embodiment;

FIG. 2B is a flowchart of a method performed on the content processor of the recruiter applicant tracking system of FIG. 1 in accordance with at least one embodiment;

FIG. 3 is a block diagram showing recruitment database records accordance with at least one embodiment;

FIG. 4 is a block diagram showing recruiter match records in accordance with at least one embodiment;

FIG. 5 is a flowchart of a method for creating a new recruitment database record in accordance with at least one embodiment;

FIG. 6 is a flowchart of a method for creating a candidate record in accordance with at least one embodiment;

FIG. 7 is a flowchart of a method for creating a job description record in accordance with at least one embodiment;

FIG. 8 is a flowchart of a method for creating ranking information in accordance with at least one embodiment;

FIG. 9 is a flowchart of a method for creating structured information in accordance with at least one embodiment;

FIG. 10 is a flowchart of a method for creating a recruiter match record in accordance with at least one embodiment;

FIG. 11 is a flowchart of a method for recruiter verification and submission of a recruiter match record to a hiring employer in accordance with at least one embodiment;

FIG. 12A and FIG. 12B are a graphical user interface for entry of job description and receipt of match results in accordance with at least one embodiment; and,

FIG. 13 is a graphical user interface for display of match results and entry of ranking information.

### DETAILED DESCRIPTION OF VARIOUS EMBODIMENTS

It will be appreciated that for simplicity and clarity of illustration, where considered appropriate, reference numerals may be repeated among the figures to indicate corresponding or analogous elements. In addition, certain specific details may be included to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein, but rather as merely describing the implementation of various example embodiments described herein.

The system and method for candidate matching described herein provides recruiters with an applicant tracking system, which integrates employers, recruiters, and candidates into one system. Recruiters are provided with a matched list of candidates without the need to enter job description or candidate information or to perform other Boolean or manual searching. Upon receiving a new candidate or job description, a recruiter also receives a sorted list of the candidates to which they are associated. The list is sorted based on previously defined criteria. These criteria are applied to a set of structured data generated out of free form candidate, job description and ranking data.

The system and method create structured information from the free form text of resumes, job descriptions, and ranking information using a rule based matching algorithm. Upon receipt of a new job description, the system and method automatically create a structured job description. Previously structured candidate profiles are then matched and ranked to the structured job description. In addition, ranking information for the job descriptions is converted into structured data and further used to improve the matching process.

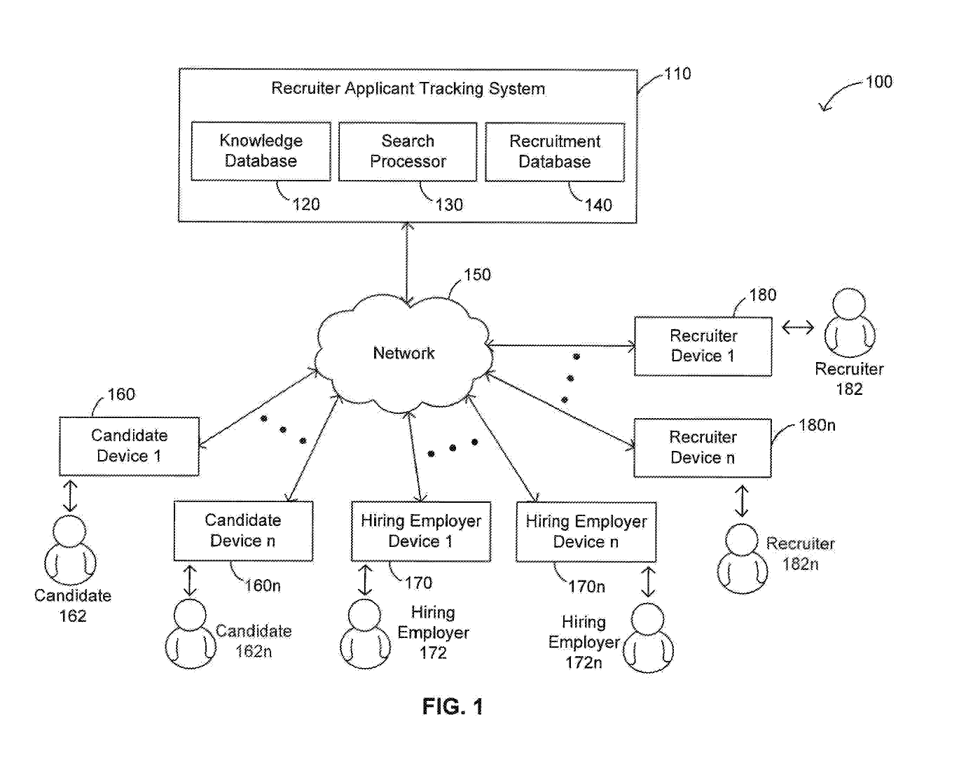

Reference is now made to FIG. 1, which illustrates a recruiter applicant tracking marketplace 100 in accordance with at least, one embodiment. The recruiter applicant tracking marketplace 100 includes candidate devices 160 to 160n, hiring employer devices 170 to 170n, and recruiter devices 180 to 180n. These devices collectively connect candidates 162 to 162n, hiring employers 172 to 172n, and recruiters 182 to 182n to a recruiter applicant tracking system 110 via a network 150. The recruiter applicant tracking system 110 comprises a knowledge database 120, a search processor 130, and a recruitment database 140.

In an embodiment, a managing company (not shown) has access to and control of all data in recruitment database 140. In a further embodiment, a managing company can manage and alter records in database 140 including, for example, hiring employer records, recruiter records, candidate records, job description records, and match records.

Recruiter applicant tracking system 110 may be implemented using, for example, a general-purpose computer capable of responding to and executing instructions in a defined manner, a personal computer, a special purpose computer, a workstation, a server, a device, a component, or other equipment or some combination thereof capable of responding to and executing instructions. While the recruiter applicant tracking system 110 is described as comprising search processor 130, knowledge database 120, and recruitment database 140 it will be understood by those skilled in the art that the recruiter applicant tracking system 110 may comprise any number of databases and processors, which implement the system.

Candidate devices 160 to 160n may be operated by, for example, candidate users 162 to 162n. Candidate users 162 to 162n are individuals looking for employment with an employer of hiring employers 172 to 172n. Candidate users 162 to 162n rely on a recruiter of a plurality of recruiters 182 to 182n to facilitate matching to a hiring employer.

Hiring employer devices 170 to 170n may each be operated by, for example, an individual at a hiring employer of hiring employers 172 to 172n. An individual who is associated with the hiring employer and who is in charge of administering the hiring of a candidate may operate the hiring employer device of hiring employer devices 172 to 172n. The hiring employer may have a current or potential employment position that it is seeking to match to an acceptable candidate. The acceptable candidate may be internal or external to the hiring employer. Hiring employer users 172 to 172n rely on a recruiter of a plurality of recruiters 182 to 182n to facilitate matching to an acceptable candidate.

Recruiter devices 180 to 180n may be operated by, for example, an individual recruiter or a recruiting company of a plurality of recruiters or recruiting companies 182 to 182n. A recruiter company user may represent a plurality of recruiters or act as a conduit for an individual recruiter within a recruiting company. Recruiters or recruiting companies 182 to 182n may facilitate matching between hiring employers 172 to 172n and candidates 162 to 162n.

It will be appreciated that the recruiter applicant tracking marketplace 100 is not limited to devices 160 to 160n, 170 to 170n, and 180 to 180n or users 162 to 162n, 172 to 172n, or 182 to 182n. The recruiter applicant tracking marketplace 100 may comprise an unlimited number of user devices operated by any number of various users. Further, it is contemplated that users may access network 150 from a multiple and a variety of different devices and need not use the same device each time a user accesses the recruiter applicant tracking system 110 via network 150.

Each of devices 160 to 160n, 170 to 170n, and 180 to 180n is preferably implemented by the use of one or more general purpose computers, such as, for example, a typical personal computer manufactured by Dell™, Gateway™, or Hewlett-Packard™. Those skilled in the art will understand that the user devices 160 to 160n, 170 to 170n, and 180 to 180n may be a laptop computer, a personal digital assistant (PDA), a mobile phone, a set top box, an interactive television or the like.

The user devices 160 to 160n, 170 to 170n, and 180 to 180n may include a microprocessor. The microprocessor can be any type of processor, such as, for example, any type of general-purpose microprocessor or microcontroller, a digital signal processing (DSP) processor, an application specific integrated circuit (ASIC), a programmable read-only memory (PROM), or any combination thereof.

The user devices 160 to 160n, 170 to 170n, and 180 to 180n can also include computer memory, such as, for example, random-access memory (RAM). However, the computer memory of user devices 160 to 160n, 170 to 170n, and 180 to 180n can be any type of computer memory or any other type of electronic storage medium that is located either internally or externally to the user devices 160 to 160n, 170 to 170n, and 180 to 180n, such as, for example, read-only memory (ROM), compact disc read-only memory (CDROM), electro-optical memory, magneto-optical memory, erasable programmable read-only memory (EPROM), and electrically-erasable programmable read-only memory (EEPROM), or the like.

According to exemplary embodiments, the corresponding RAM can contain, for example, a web browser application for the user devices 160 to 160n, 170 to 170n, and 180 to 180n. The web browser application typically will communicate with the network 150 to allow a user 162 to 162n, 172 to 172n, or 182 to 182n operating a user device 160 to 160n, 170 to 170n, and 180 to 180n to access and participate in a recruitment system interface hosted by recruiter applicant tracking system 110.

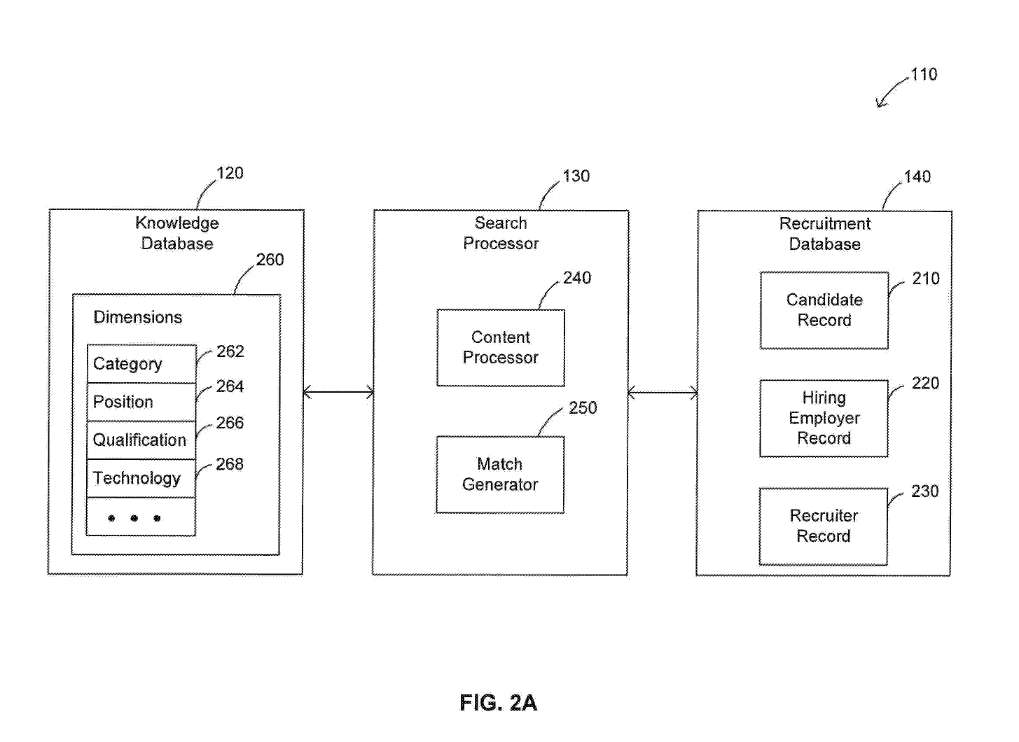

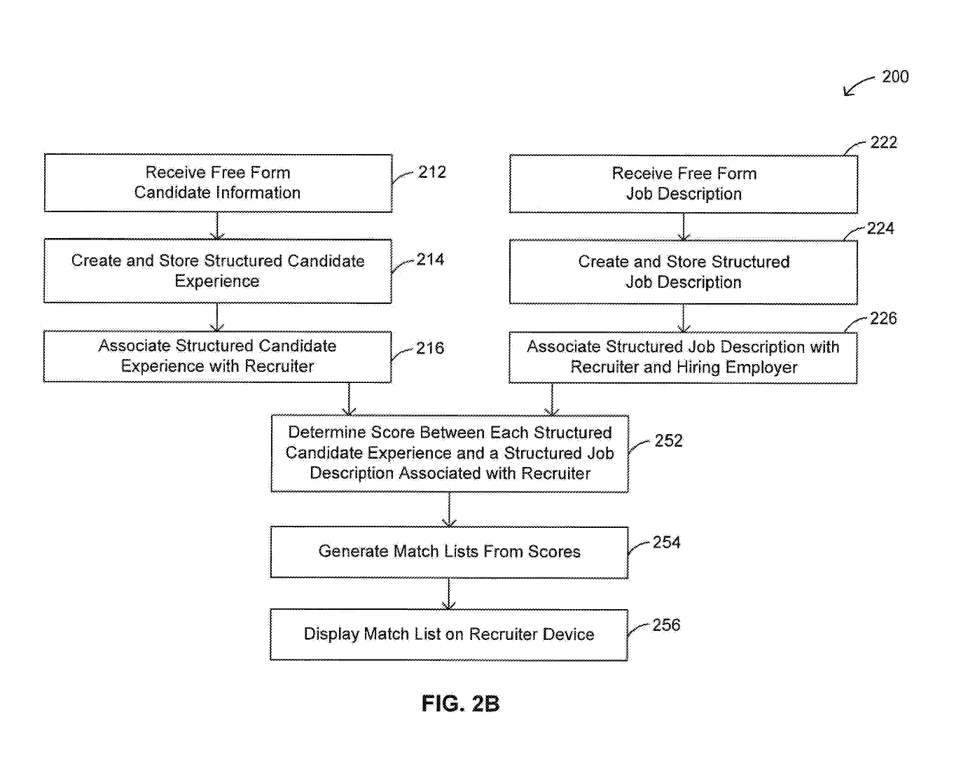

Recruiter applicant tracking system 110 hosts one or more recruitment system interfaces. Recruiter applicant tracking system 110 typically includes a web server (not shown) to receive and respond to network requests made by the web browser of user device 160 to 160n, 170 to 170n, and 180 to 180n. An exemplary recruiter applicant tracking system 110 will be described in greater detail in reference to FIG. 2A and FIG. 2B.

The network 150 may be a local area network (LAN), a wide area network (WAN), the Internet, analog or digital wired and wireless telephone networks (e.g. a Public Switched Telephone Network (PSTN), an Integrated Services Digital Network (ISDN), or a Digital Subscriber Line (xDSL)), or any other wired or wireless network. The network 150 may include multiple networks or subnetworks, each of which may include, for example, a wired or wireless communications channel.

Reference is now made to FIG. 2A, which illustrates an exemplary embodiment of recruiter applicant tracking system 110 of FIG. 1. In the exemplary embodiment shown in FIG. 2A, search processor 130 includes a content processor 240 and a match generator 250. A knowledge database 120 defines dimensions 260. In an additional embodiment, dimensions 260 may be ordered in a hierarchical relationship with each other. The dimensions or hierarchical dimensions may comprise, for example: one or more categories 262, one or more positions 264, one or more qualifications 266 and one or more technologies 268. Knowledge database 120 is extensible. Although 4 dimensions are shown in the exemplary embodiment, additional dimensions may be added. For example, in addition to technologies 268, a “Use” dimension (not shown) could capture what might be done with a particular technology. One dimension can be related or correlated with another.

The use of knowledge database 120 contributes to overall efficiency of the recruiter applicant tracking system. The pre-established structure of the dimensions of the knowledge database 120 enables a small response time. The response time for generation of a recruiter match list is significantly lower than if a free form keyword search is conducted on free form content.

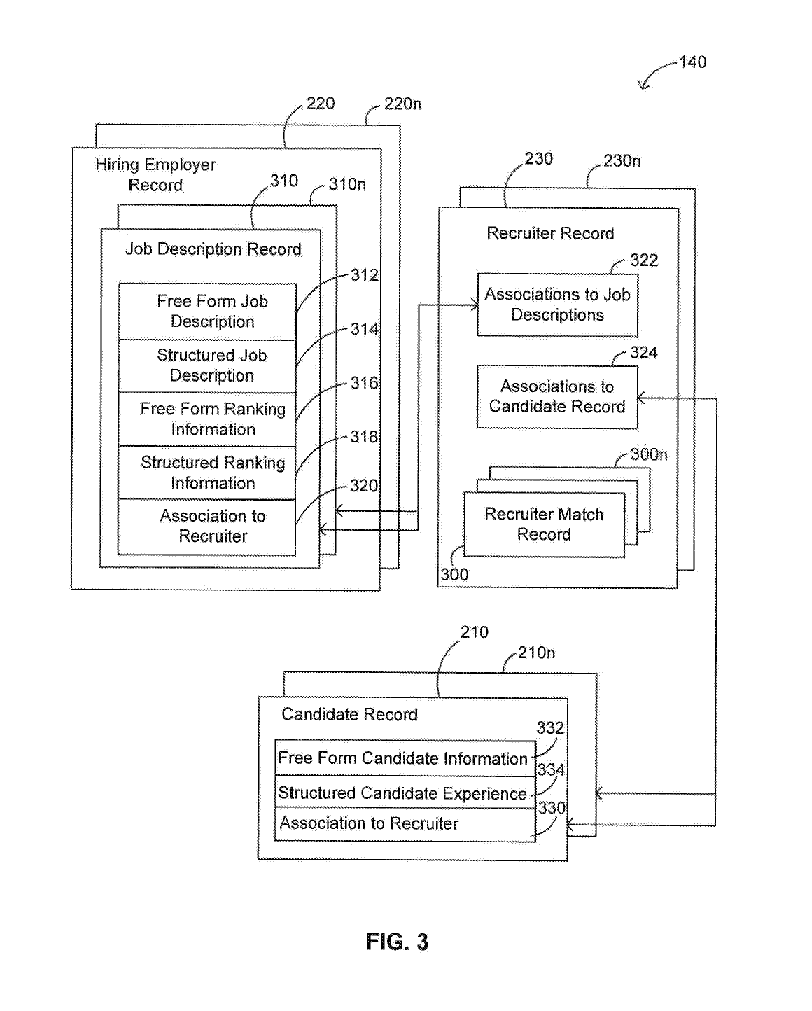

Recruitment database 140 stores at least one candidate record 210, at least one hiring employer record 220, and at least one recruiter record 230. An exemplary recruitment database 140 will be described in greater detail in reference to FIG. 3.

Reference is now made to FIG. 2B in which a method 200 for facilitating recruitment using an applicant tracking system and by providing a top candidate to a recruiter based on a job request of a hiring employer is illustrated. In an exemplary embodiment, search processor 130 of recruiter applicant tracking system 110 of FIG. 1 performs method 200 for facilitating recruitment.

Recruiter applicant tracking system 110 receives free form candidate information 332 at 212. Content processor 240 creates structured candidate experience 334 based on free form candidate information 332 and dimensions 260 of knowledge database 120 at 214. Recruitment database 140 stores structured candidate experience 334 in candidate record 210 at 216. Also at 216, structured candidate experience 334 is associated with a recruiter record 230.

Recruiter applicant tracking system 110 receives a free form job description 312 at 222. Content processor 240 creates a structured job description 314 based on free form job description 312 and dimensions 260 of knowledge database 120 at 224. Recruitment database 140 stores structured job description 314 in hiring employer record 220 at 226. Also at 226, structured job description 314 is associated with a recruiter record 230.

At 252, match generator 250 determines a score that is used for matching a job description and candidates associated with a recruiter record 230. Each score is generated between each structured candidate experience 334 to 334n and a structured job description 314 associated with the same recruiter record 230. At 254, match generator 250 creates recruiter match records 300 to 300n. Each match record 300 comprises the score of each structured candidate experience 334 associated with the recruiter 182 in relation to a specific structured job description 314. At 256, recruiter match record 300 is displayed on recruiter device 180.

Reference is now made to FIG. 3, in which an exemplary embodiment of recruitment database 140 of recruiter applicant tracking system 110 of FIG. 1 is illustrated. In the exemplary embodiment shown in FIG. 3, recruitment database 140 stores one or more candidate records 210 to 210n, one or more hiring employer records 220 to 220n, and one or more recruiter record 230 to 230n.

Candidate records 210 to 210n may each comprise free form candidate information 332 associated with one of employment candidates 162 to 162n. Free form candidate information 332 may, for example, be input by a candidate 162 on a candidate device 160. Free form candidate information 332 may also be input by a recruiter 182 on a recruiter device 180. Free form candidate information 332 may also be obtained via network 150 via known methods of data collection or data aggregation.

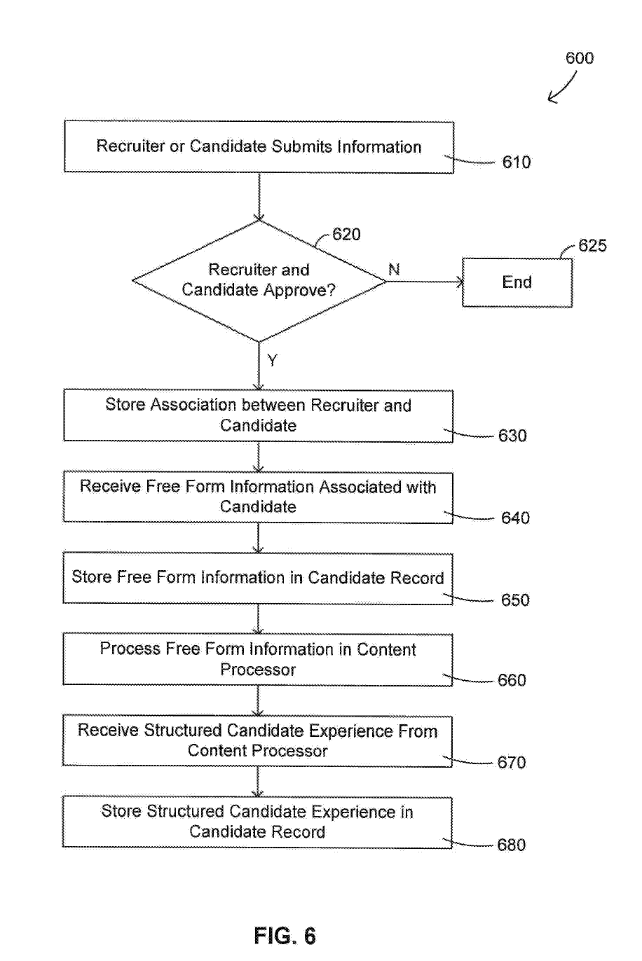

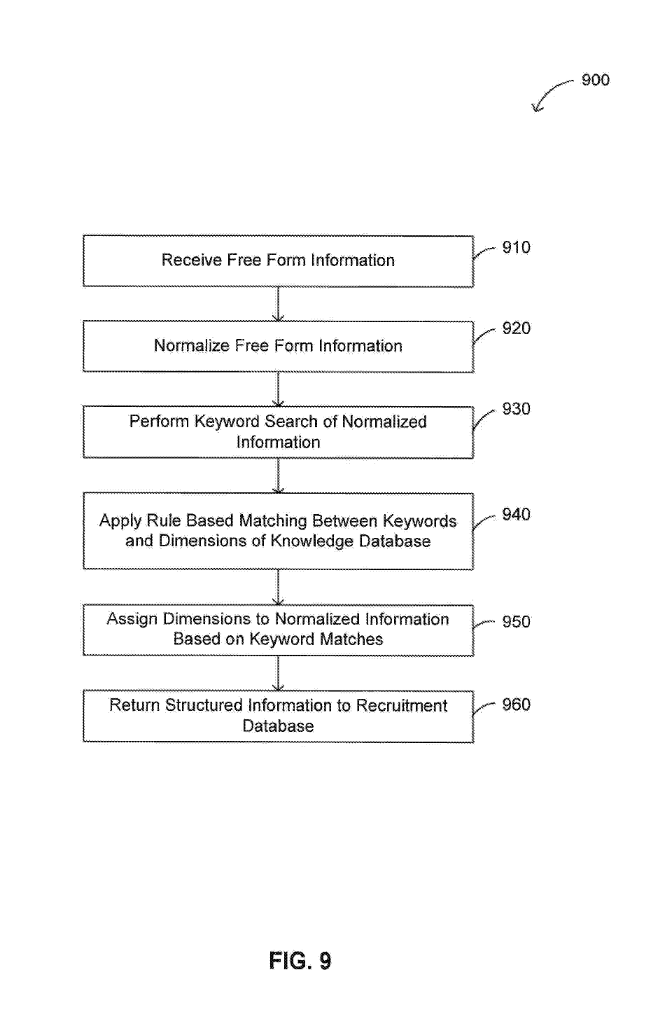

A candidate record 210 may comprise a structured candidate experience 334 created using search processor 130 and knowledge database 120 of recruiter applicant tracking system 110. Structured candidate experience 334 comprises hierarchical dimensions (not shown). Content processor 240 of search processor 130 assigns these dimensions or hierarchical dimensions to the free form candidate information 332. The assignment is performed using rule based matching to dimensions 260 of knowledge database 120. An exemplary method of creating a structured candidate experience 334 from free form candidate information 332 (i.e. by assigning dimensions) will be described in greater detail in reference to FIGS. 6 and 9.

Candidate record 210 may comprise an association 330 to a recruiter record 230. Association 330 between candidate record 210 and recruiter record 230 may be initiated by either candidate 162 or recruiter 182. In an exemplary embodiment, recruiter applicant tracking system 110 may require candidate 162, recruiter 182, or both to approve association 330 prior to its creation.

Hiring employer records 220 to 220n comprise information relating to hiring employers 172 to 172n. A hiring employer record 220 may comprise one or more job description records 310 to 310n. In an exemplary embodiment, a job description record 310 may comprise, for example, free form job description 312, structured job description 314, free form ranking information 316, structured ranking information 318, and association to a recruiter 320.

Job description record 310 may be associated with one of hiring employers 172 to 172n. Free form job description 312 may, for example, be input by a hiring employer 172 on a hiring employer device 170. Free form job description 312 may also be input by a recruiter 182 on a recruiter device 180. Free form job description 312 may also be obtained via network 150 via known methods of data collection or data aggregation.

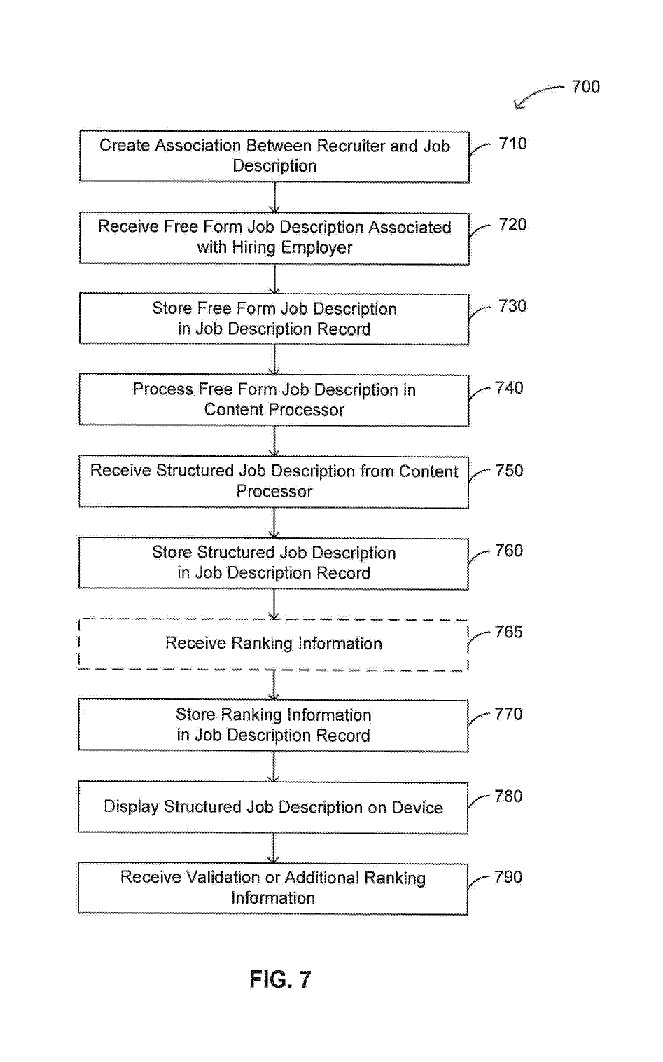

Job description record 310 also comprises a structured job description 314 created using search processor 130 and knowledge database 120. Structured job description 314 includes dimensions, which may be ordered in a hierarchical relationship with each other (not shown). Content processor 240 of search processor 130 assigns these dimensions or hierarchical dimensions to free form job description 312. This assignment is performed using rule based matching to a set of hierarchical dimensions 260 of a knowledge database 120. An exemplary method of assigning dimensions to create a structured job description 314 from free form job description 312 will be described in greater detail in reference to FIGS. 7 and 9.

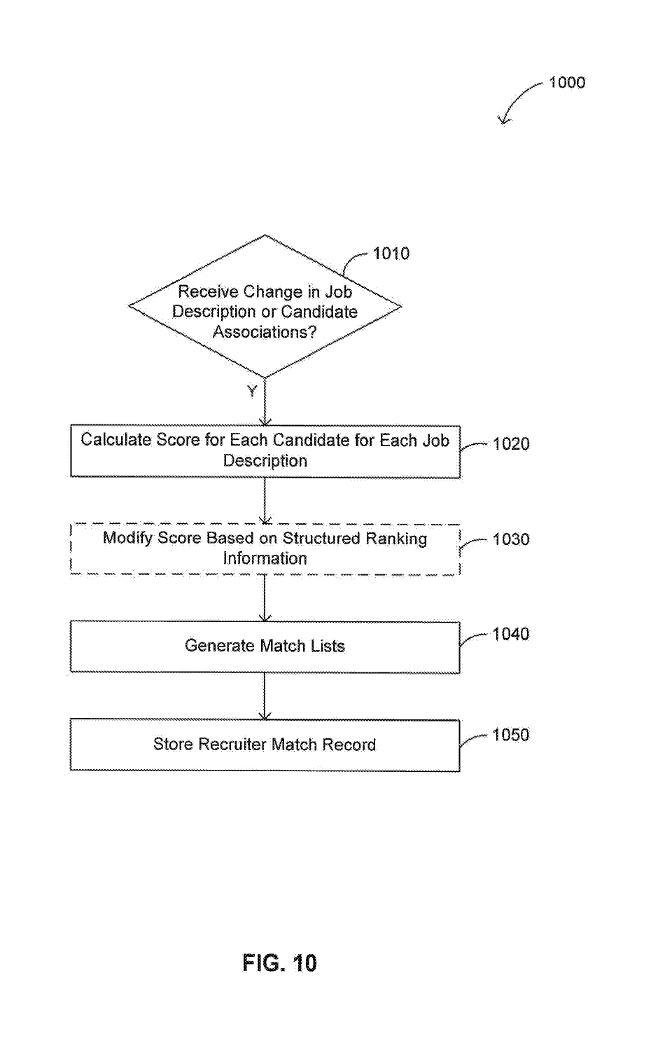

Job description record 310 may also comprise free form ranking information 316 and structured ranking information 318. Ranking information may be used to modify the match results. Candidate matching will be described in greater detail in reference to FIG. 10. Based on ranking information, the same structured data can result in a different match list or record. In addition, further modification of ranking information may be used to further modify a match list or record. Similarly to free form job description 312, free form ranking information 316 may, for example, be input by hiring employer 172 on hiring employer device 170 or by recruiter 182 on recruiter device 180.

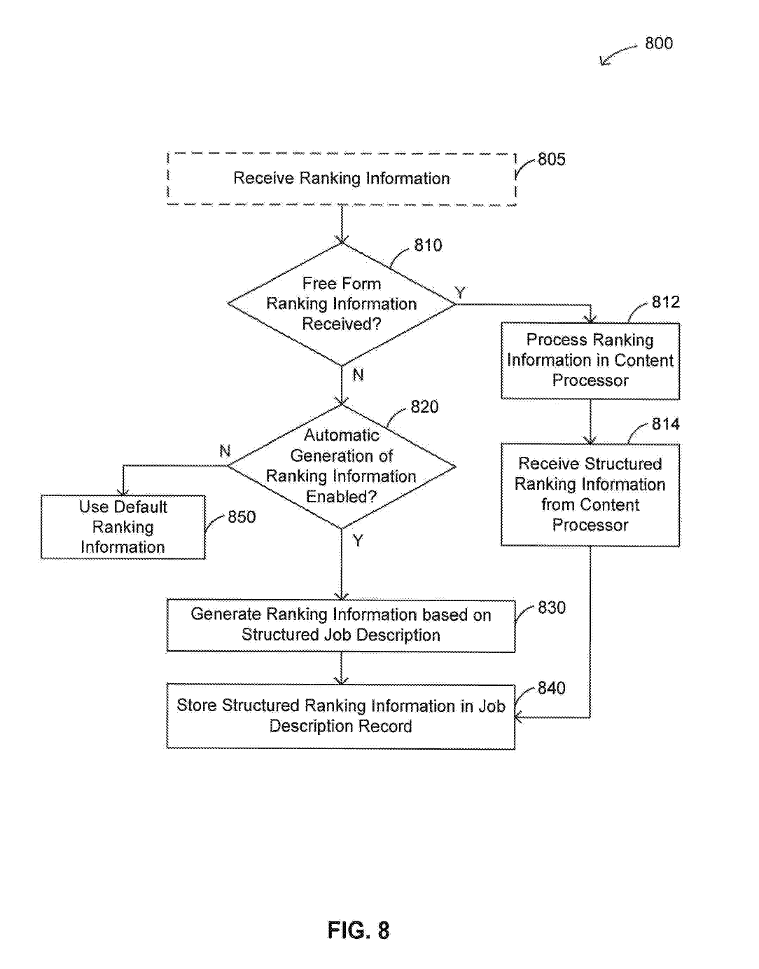

Free form ranking information 316 may be used to create structured ranking information 318. Structured ranking information may be created using search processor 130 and knowledge database 120 of recruiter applicant tracking system 110. Structured ranking information 318 includes dimensions, which may be ordered in a hierarchical relationship with each other (not shown). Content processor 240 assigns dimensions or hierarchical dimensions to free form ranking information 316. The assignment is performed using rule based matching to dimensions 260 of knowledge database 120. Structured ranking information 318 may be used to prioritize dimensions of the structured job description 314 during candidate matching. An exemplary method of creating structured ranking information 318 from free form ranking information 316 will be described in greater detail in reference to FIGS. 8 and 9.

In an alternate embodiment, job description 310 may not comprise free form ranking information 316. Accordingly, structured ranking information 318 may comprise default ranking information. In yet another embodiment, structured ranking information 318 may be automatically generated based on structured job description 314 or additional user input.

Job description records 310 to 310n may comprise an association 320 to a recruiter record 230 of a recruiter 182. Association 320 between a job description record 310 and a recruiter record 230 may be initiated by either hiring employer 172 or recruiter 182. In an exemplary embodiment, recruiter applicant tracking system 110 may require hiring employer 172, recruiter 182, or both to approve association 320 prior to its creation.

In an exemplary embodiment, a hiring employer 172 may create a broad association to a recruiter 182. This association may be stored, for example, in hiring employer record 220 and or in recruiter record 230. In this embodiment, all of the job descriptions 310 to 310n within the hiring employer record 220 of the hiring employer 172 may comprise an association 320 to a single recruiter record 230 of a single recruiter 182. In an alternate embodiment, job description records 310 to 310n belonging to a hiring employer record 220 may each comprise an association 320 to one or more recruiter records 230 to 230n belonging to more than one recruiters 182 to 182n.

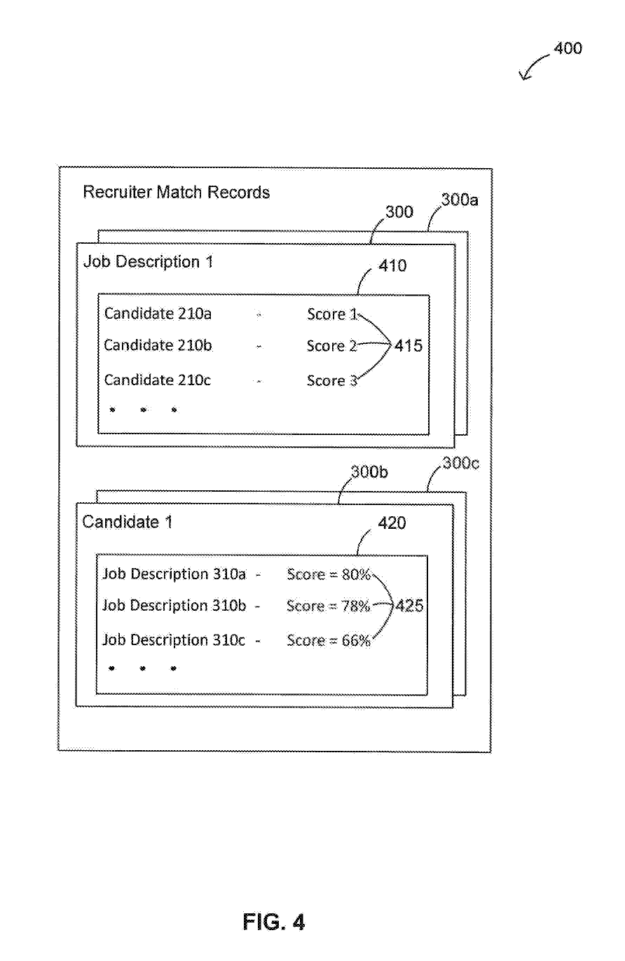

Recruiter records 230 to 230n comprise information relating to recruiters 182 to 182n. In an exemplary embodiment, a recruiter record 230 may comprise one or more associations 322 to a job description record 310, one or more associations 324 to a candidate record 210, and one or more recruiter match, records 300 to 300n. Recruiter match records 300 to 300n will be described in greater detail with reference to FIG. 4.

In an exemplary embodiment, recruiter record 230 may also comprise one or more associations (not shown) to a hiring employer 220. In such an embodiment, recruiter record 230 may comprise an association 322 to each of the job descriptions 310 to 310n of the hiring employer record 220.

Reference is now made to FIG. 4, in which an exemplary embodiment of a recruiter match record 300 of recruiter record 230 of FIGS. 2A and 3 is illustrated. Recruiter match record 300 may comprise a set of scores 415, 425. Scores 415, 425 may be depicted as a numerical value, a percentage value, as an ordered list, or etc. Creation of scores 415, 425 and recruiter match record 300 will be discussed in further detail having regard to FIG. 10.

In an exemplary embodiment, recruiter match record 300 may comprise a list 410 of all of the candidate records 210 to 210n associated with recruiter 182. List 410 may be ordered by scores 415 of each structured candidate experience 334 in relation to a particular job description 310 (shown as, for example, Job Description 1). List 410 may also comprise a subset of the candidate records 210 to 210n associated with recruiter 182, the list being ordered by scores 415 of each structured candidate experience 334 in the subset in relation to job description 310. The subset may be a subset of candidates of the candidates associated with recruiter 182 having a highest set of scores 415 in relation to a job description 310.

In another exemplary embodiment, recruiter match record 300 may comprise a list 420 of all of the job description records 310 to 310n associated with recruiter 182. List 420 may be ordered by the scores 425 of a structured candidate experience 334 in relation to each job description 310 to 310n associated with recruiter 182. List 420 may comprise a subset of the job description records 310 to 310n associated with recruiter 182. In this embodiment, the list is ordered by the scores 425 of a structured candidate experience 334 in relation to each job description 310 to 310n in the subset. The subset may be a subset of job descriptions of the job descriptions associated with recruiter 182 for which a structured candidate experience 334 has a highest score.

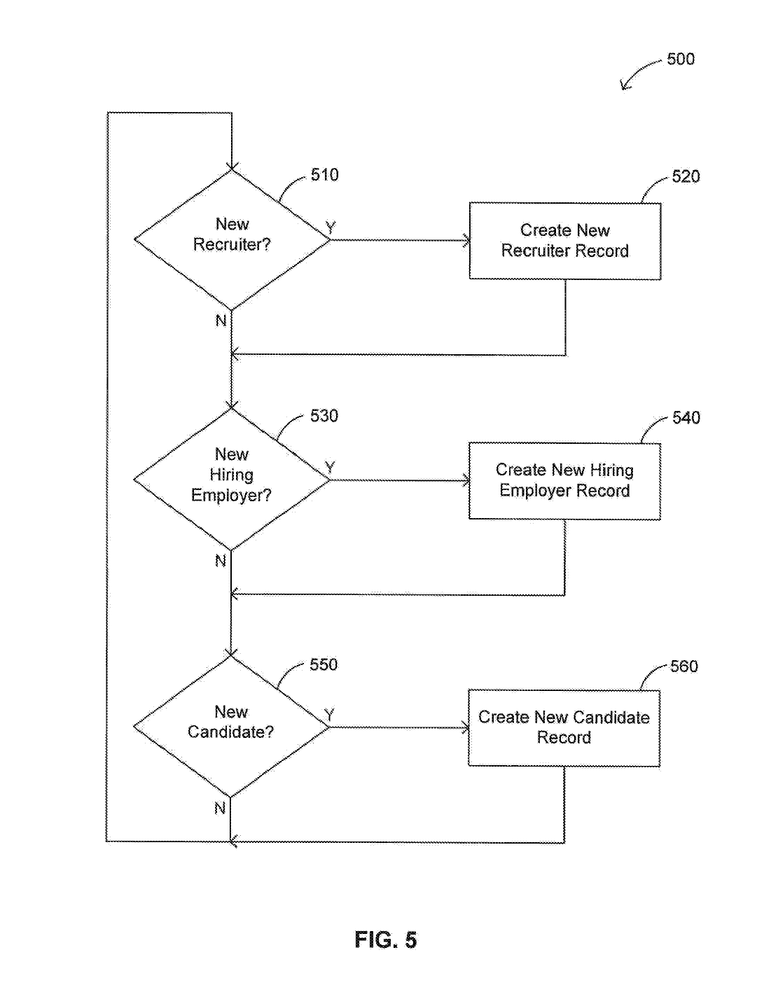

Reference is now made to FIG. 5, in which a method 500 of creating a new record in recruitment database 140 is illustrated. The method can be executed, for example, on search processor 130 of recruiter applicant tracking system 110. At 510, if new recruiter information has been received, method 500 continues to 520. At 520, a new recruiter method is created. Otherwise, if no recruiter input is received, then at 530, method 500 considers whether new hiring employer information has been received. If it has, at 540 a new hiring employer record is created. The skilled person will appreciate that information regarding a new job description record may be similarly recognized by a similar method and similarly used to create a new job description record (steps not shown).

At 550, method 500 considers whether new candidate information has been received. If so, then a new candidate record is created at 560. Reference is now made to FIG. 6, in which a method 600 of creating a new candidate record is illustrated in additional detail. The candidate record can be, for example, the candidate record 210 illustrated in FIG. 3.

In one embodiment, information relevant to candidate record 210 can be entered by either candidate 162 or recruiter 182. This information can be for example, free form candidate information 332 or an association to recruiter 330. At 610, if candidate 162 is submitting his or her own information, then, recruiter 182 is requested 620 to approve an association to candidate 162. Conversely, candidate 162 may be requested to approve an association to recruiter 182. In one embodiment without requisite approvals method 600 ends at 625. Alternately, method 600 may proceed directly to 630. At 630, association 330 is stored in candidate record 210. A corresponding association 324 would be stored in recruiter record 230.

At 640, free form candidate information 332 is received by recruiter applicant tracking system 110 over network 150. Free form candidate information 332 may be received by, for example, search processor 130 or content processor 240. At 640, free form candidate information 332 is stored in candidate record 210. At 660, free form candidate information is processed in content processor 240. At 670, structured candidate experience 334 is returned by the content processor 240. At 680, structured candidate experience 334 is stored in candidate record 210. Creation of structured information from free form information as in for example, step 660, will be discussed in further detail having regard to FIG. 9.

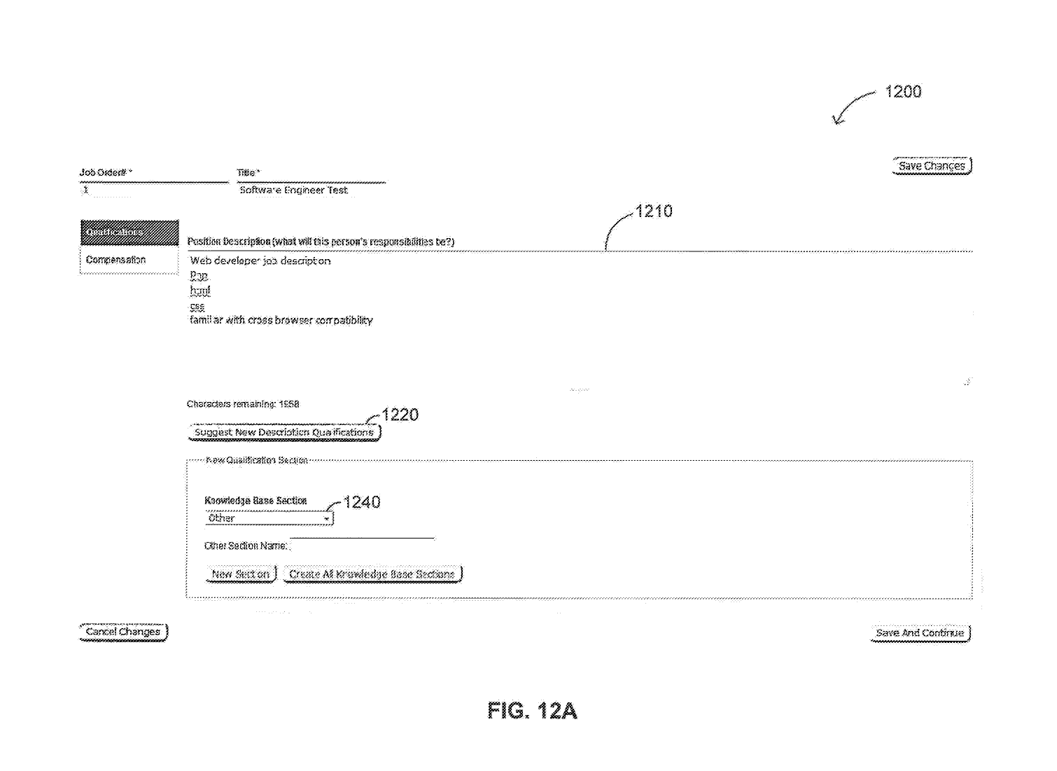

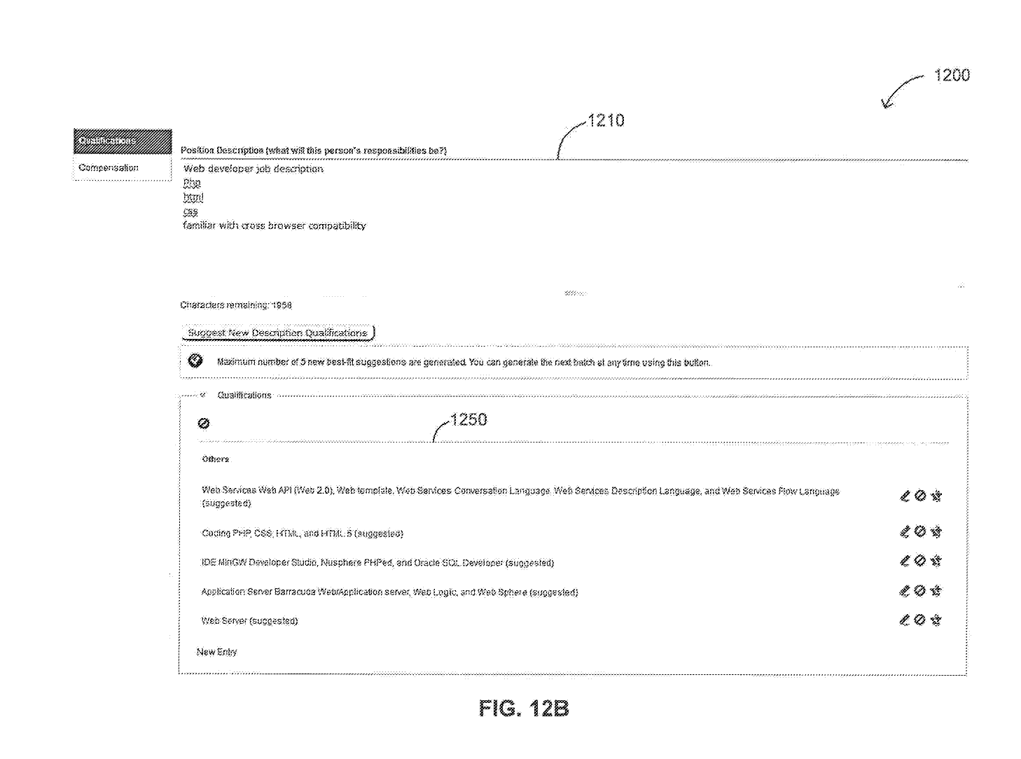

Reference is now made to FIGS. 7, 12A, and 12B in which a method and exemplary user interface for creating a new job description record are illustrated. The job description record can be, for example, the job description record 310 illustrated in FIG. 3.

In one embodiment, information relevant to job description record 310 can be entered by either hiring employer 172 or recruiter 182. This information may be, for example, free form job description 312 or association to a recruiter 320. As discussed above with reference to FIG. 3, a hiring employer 172 may associate all job records 310 to 310n contained in their hiring employer record 220 to a particular recruiter 182 or set of recruiters. Alternately, hiring employer 172 can associate each job record 310 differently among a set of recruiters. A hiring employer 172 may be requested to validate a job record 310 or association 320, 322 created by a recruiter 182 or vice versa.

At 710, association 320, 322 may be entered by either recruiter 182 or hiring employer 172. Association 320, 322 may be automatically established by a previous arrangement between recruiter 182 and hiring employer 172. At 720, free form job description 312 is entered by recruiter 182 or hiring employer 172 and received by the recruiter applicant tracking system 110 over network 150. Free form job description 312 may be entered using, for example, input box 1210 of interface 1200 (FIG. 12), which may be displayed on recruiter device 180 or hiring employer device 170. At 730, free form job description 312 may be stored in job description record 310.

Free form job description 312 is processed in content processor 240 at 740. Structured job description 314 is returned by the content processor 240 at 750. Structured job description 314 is stored in job description record 310 at 760. Creation of structured information from free form information as in, for example, step 740, will be discussed in further detail having regard to FIG. 9.

In an additional embodiment, recruiter applicant tracking system 110 may suggest additional content for structured job description 314 based on existing content. For example, recruiter 182 or hiring employer 172 can select a “suggest new description qualifications” pushbutton 1220 in interface 1200. Interface 1200 may then display additional suggested qualifications 1250.

At 765, ranking information may be received by the recruiter applicant tracking system 110 over network 150. The ranking information may comprise for example, free form ranking information 316. The ranking information may also comprise an instruction to the recruiter applicant tracking system 110 to automatically generate structured ranking information 318 based on structured job description 314. The ranking information may comprise input from recruiter 182 or hiring employer 172. This input may be input directly into structured form. Default ranking information may also be used if no ranking information is received. Structured ranking information 318 is stored at 770. Entry and processing of ranking information will be discussed in further detail with reference to FIG. 8.

At 780, structured job description 318 is displayed on an interface (not shown) of recruiter device 180 or hiring employer device 170. At 790, the recruiter 182 or hiring employer 172 may provide validation of the job description. In addition, recruiter 182 or hiring employer 172 may modify free form job description 312 or ranking information and recruiter applicant tracking system 110 may update job description record 310 accordingly.

Reference is now made to FIG. 8, in which a method 800 of creating ranking information is illustrated. The ranking information may be, for example, structured ranking information 318 depicted in FIG. 3. In one embodiment, a ranking information comprises free form ranking information 316 entered and/or modified by recruiter 182 or hiring employer 172.

Ranking information received at 805 may be in free form, structured form, or may comprise an instruction to automatically generate the ranking info. Alternately at 805, no ranking information may be received. If recruiter applicant tracking system 110 receives no ranking information from recruiter 182 or hiring employer 172, then at 850, default ranking information may be stored. If, at 810, free form ranking information 316 has been received then the free form ranking information 316 is processed by content processor 240 at 812 and content processor 240 returns structured ranking information 318 at 814. Creation of structured information from free form information, for example 812, will be discussed in further detail having regard to FIG. 9.

At 820, if free form ranking information 316 has not been received but recruiter 182 or hiring employer 172 has enabled automatic generation of ranking information, then at 830 content processor 240 will generate structured ranking information 318 based on structured job description 314.

In an additional embodiment, ranking information may be received from the recruiter 182 or hiring employer 172 in a structured format (not shown). For example, recruiter 182 or hiring employer 172 may enter ranking information by selecting option buttons, check boxes, by positioning sliders, or other types of input into a user interface (not shown). At 840, structured ranking information 318 is stored in job description record 310.

Reference is now made to FIG. 9, in which an exemplary method 900 of generating structured information from free form information is illustrated. A person skilled in the art will recognize that other known means of generating structured information from free form information, such as natural language processing, may provide a viable substitute to exemplary method 900. At 910, free form information (for example, free form candidate information 332, free form job description 312, or free form ranking information 316) is received by content processor 240.

At 920, the free form text may be normalized by, for example, eliminating trivial words, transforming plurals into singular, and etc. At 930, keyword matching is performed between the normalized words and the dimensions 260 of knowledge database 120. If a keyword match is found between the normalized texted and a dimension, then a mark indicating the keyword match is saved. Each mark may have an optional range associated with it.

At 940, rule based matching is applied between the marks saved at 930 and dimensions 260. Marks saved at 930 are aggregated and the related keywords are sorted by significance, considering, for example, number of matches, priority, and weights. A set of the most significant dimensions may be selected using a threshold or correlation algorithm. These dimensions are assigned to the normalized information at 950. Additional dimensions can be added to knowledge database 120 without modification to the rules used in rule based matching at 940.

In an additional embodiment, dimensions 260 may comprise a best fit range. If a best fit range has been defined each keyword is further matched against the range. At 960, structured information, for e.g. 314, 318, or 334, is returned to recruitment database 140.

Reference is now made to FIG. 10, in which an exemplary method 1000 of creating a new match record in recruiter record 230 is illustrated. The match record may be one of recruiter match records 300 to 300n as illustrated in FIG. 4. This method may be executed by, for example, match generator 250 of FIG. 2A. At 1010, match generator 250 receives a change in associations 322 or 324 of any one of recruiter records 230 to 230n. A change in associations 322 may be, for example, due to a new affiliation with a hiring employer or to receipt of a notification that a hiring employer has filled a recent job order. A change in associations 324 may be, for example, due to entry of a new candidate, or because an existing candidate is no longer eligible for recruitment.

A change in the associations 322 or 324 of recruiter record 230 may necessitate creation of a new recruiter match record. Such a change may also necessitate an update to existing match records. For example, at 1020, upon receipt of a new association 322 to a job description record 310, match generator 250 calculates a score 415, 425 for each candidate record having an association 324 to recruiter record 230. Match generator 250 may also update any match lists 410, 420, which are identified by candidate, to include a score 415, 425 for the new job description record. A removal of a job record, or addition or removal of a candidate record may necessitate similar score calculations at 1020.

Scores may be represented as, for example, a numerical value, an order of preference 415, and/or as percentage values 425. Scores may be calculated based on a distance between the dimensions of structured job description 314 and structured candidate experience 334. In an additional embodiment, at 1030, structured ranking information 318 may be used to modify a score associated with each dimension of structured job description 314 and/or structured candidate experience 334. The scores associated with each dimension may then be aggregated into an overall score 415 or 425.

At 1050 matches between a job description and candidates, or candidate and job descriptions, and scores 415, 425 for each match are stored as a new recruiter match record.

In an exemplary embodiment, at 1040, job description 310, its matched candidate records, and corresponding scores 415, 425 are stored as a list 410. List 410 may comprise a subset of the candidate records 210 to 210n associated with recruiter 182, the list being ordered by the scores 415, 425 of each structured candidate 334 in the subset in relation to a job description 310. The subset may be a subset of candidates of the candidates associated with recruiter 182 having a highest set of scores 415 in relation to a job description 310. The subset may also be a subset of candidates of the candidates associated with recruiter 182 having scores with a minimum calculated distance between the dimensions of the structured candidate experience and the dimensions of the structured job description.

Alternately at 1040, candidate record 210, its matched job descriptions, and corresponding scores 415, 425 are stored as list 420. List 420 may comprise a subset of the job description records 310 to 310n associated with recruiter 182, the list being ordered by the scores 415, 425 of structured candidate experience 334 in relation to each job description 310 to 310n in the subset. The subset may be a subset of job descriptions of the job descriptions associated with recruiter 182 for which a structured candidate experience 334 has a highest score. The subset may also be a subset of job descriptions of the job descriptions associated with recruiter 182 having scores with a minimum calculated distance between the dimensions of the structured candidate experience and the dimensions of the structured job description.

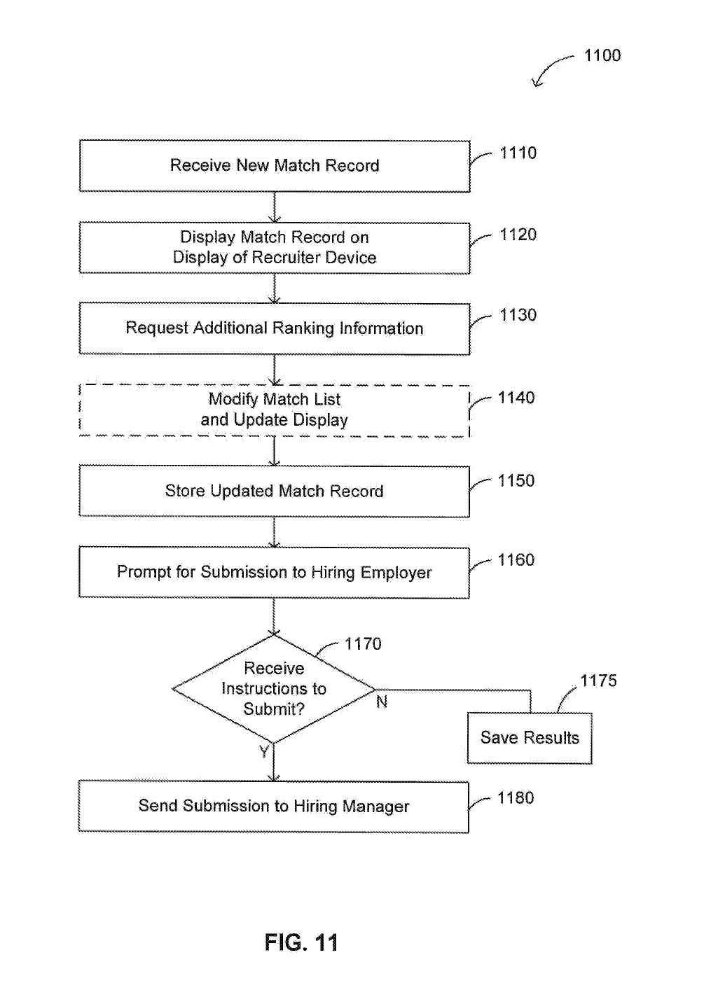

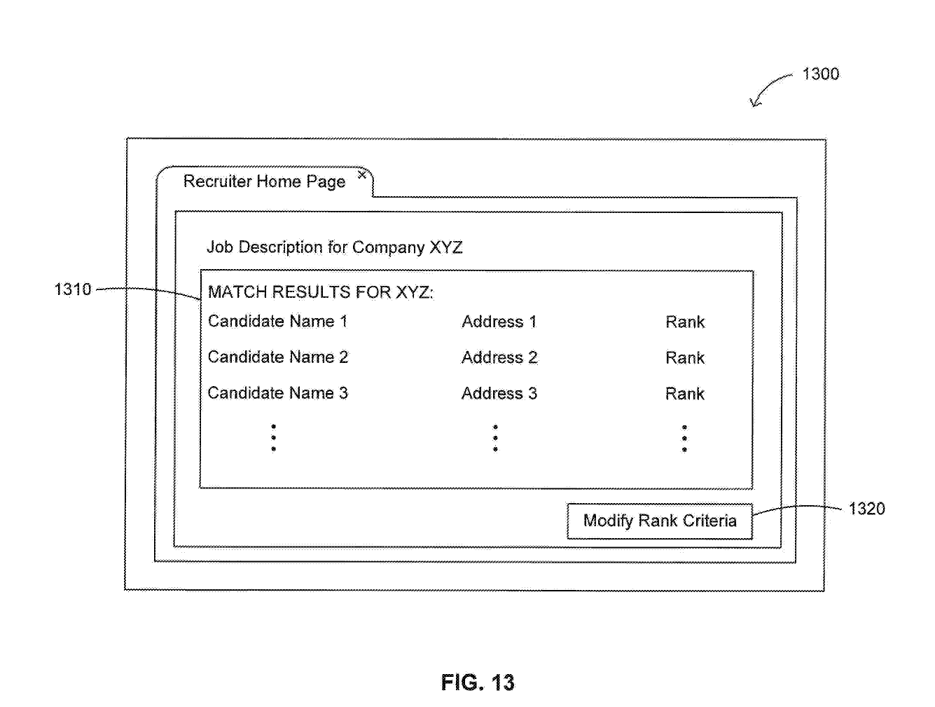

Reference is now made to FIG. 11, in which a method 1100 of recruiter verification of match records is illustrated. The match record may be a new match record as created by method 1000 illustrated in FIG. 10. Alternately, method 1100 may be used to verify an existing match record 300 to 300n. Reference is also made to FIG. 13, in which a user interface for displaying match results on recruiter device 180 is illustrated.

At 1110, recruiter device 180 receives a new match record from applicant tracking system 110 via network 150. At 1120, the match records are displayed in user interface 1310 on recruiter device 180. User interface 1300 may be displayed on, for example, a display or touchscreen. User interface 1300 may include, for example, match results 1310, candidate information, ranking results, or other information. At 1130 additional ranking information can be received, using, for example, pushbutton 1320, according to method 800 described above with reference to FIG. 8.

At 1140, match results may be modified based on any additional ranking input. The updated results may be displayed in match results 1310 on recruiter device 180 so that recruiter 182 may evaluate the impact of modification to the ranking information. Match records 300 to 300n and job description records 310 to 310n may be modified in response to the new ranking information. At 1150, recruiter 182 may indicate that the updated recruiter match records and ranking information be stored.

At 1160, the recruiter application tracking system 110 may prompt recruiter 182 for submission of a best candidate to hiring employer 172. The best candidate may be suggested based on recruiter match results. For example, the suggestion may be based on score 415 or 425, which was previously stored in match record 300 in association to job description record 310. A submission to hiring employer 182 may comprise, for example, free form candidate information such as a resume and cover letter. A submission may also comprise structured candidate experience 334.

At 1170, recruiter 182 may approve the submission, and then at 1180 the submission will be sent to hiring employer 182 via device 180. If, at 1170, recruiter 182 declines to make a submission, then at 1175 the existing suggestions may be stored for later follow-up.

While the above description provides examples of the embodiments, it will be appreciated that some features and/or functions of the described embodiments are susceptible to modification without departing from the principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for facilitating recruitment using an applicant tracking system to provide a top candidate for employment to a recruiter based on a job description of a hiring employer, the method comprising:
creating and storing at least one structured candidate experience based on free form information associated with a candidate, the candidate experience associated with a recruiter of a plurality of recruiters;
creating and storing a structured job description based on a free form job description associated with the hiring employer and with the recruiter;
determining a score between each structured candidate experience and the structured job description associated with the recruiter;
generating a match list from the scores associated with the recruiter; and
displaying the match list on a recruiter device.

2. The method of claim 1, wherein
creating the structured candidate experience comprises assigning hierarchical dimensions to the free form information associated with the employment candidate;
creating the structured job description comprises assigning hierarchical dimensions to the free form job description; and
the hierarchical dimensions are defined in a knowledge database.

3. The method of claim 2, wherein assigning the hierarchical dimensions comprises using rule based matching to determine a number of keyword matches between the hierarchical dimensions of the knowledge database and the free form information associated with the employment candidate or the free form job description.

4. The method of claim 2, wherein determining the score for each structured candidate experience comprises calculating a distance between the hierarchical dimensions of the structured candidate experience and the hierarchical dimensions of the structured job description.

5. The method of claim 4, comprising:
creating structured ranking information based on at least one of: default rank criteria, free form ranking information associated with a hiring employer, and the structured job description,
the structured ranking information comprising hierarchical dimensions defined in the knowledge database; and
the score for each structured candidate experience is further based on the structured ranking information.

6. The method of claim 5, wherein the generated match list comprises a subset of the plurality of structured candidate experiences, the subset comprising the structured candidate experiences with scores having a minimum calculated distance between the hierarchical dimensions of the structured candidate experience and the hierarchical dimensions of the structured job description.

7. The method of claim 1, comprising:
receiving a recruiter submission at a hiring employer device, wherein the recruiter submission comprises the match list.

8. An applicant tracking system for facilitating recruitment to provide a top candidate for employment to a recruiter based on a job description of a hiring employer, the system comprising:
a knowledge database;
a recruitment database;
a recruiter device; and
a search processor coupled to the knowledge database and recruitment database and operable to:
receive free form information associated with a candidate;
create at least one structured candidate experience based on the free form information associated with the candidate, the candidate associated with a recruiter of a plurality of recruiters;
store a plurality of structured candidate experiences in the recruitment database;
receive a free form job description associated with a hiring employer and with the recruiter;
create a structured job description based on the free form job description;
determine a score between each structured candidate experience and the structured job description associated with the recruiter;
generate a match list from the scores associated with the recruiter; and
display the match list on a recruiter device.

9. The system of claim 8, wherein the search processor is further operable to:
create the structured candidate experience by assigning hierarchical dimensions to the free form information associated with the employment candidate;
create the structured job description by assigning hierarchical dimensions to the free form job description; and
the hierarchical dimensions are defined in the knowledge database.

10. The system of claim 9, wherein assigning the hierarchical dimensions comprises using rule based matching to determine a number of keyword matches between the hierarchical dimensions of the knowledge database and the free form information associated with the employment candidate or the free form job description.

11. The system of claim 9, wherein the search processor is operable to determine the score for each structured candidate experience by calculating a distance between the hierarchical dimensions of the structured candidate experience and the hierarchical dimensions of the structured job description.

12. The system of claim 11, wherein the search processor is further operable to
receive a submission of free form ranking information associated with a hiring employer;
create structured ranking information based on at least one of default rank criteria, free form ranking information associated with a hiring employer, and the structured job description;
the structured ranking information comprising hierarchical dimensions defined in the knowledge database; and
the score for each structured candidate experience is further based on the structured ranking information.

13. The system of claim 12, wherein the generated match list comprises a subset of the plurality of structured candidate experiences, the subset comprising the structured candidate experiences with scores having a minimum calculated distance between the hierarchical dimensions of the structured candidate experience and the hierarchical dimensions of the structured job description.

14. The system of claim 8, wherein a hiring employer device is operable to receive a recruiter submission comprising the match list.

15. A non-transitory computer readable medium for performing the steps of the method of claim 1.
